(19) United States
(12) Patent Application Publication
(10) Pub. No.: US 2004/0150645 A1
(43) Pub. Date: Aug. 5, 2004

(54) Methods and computer systems for rendering displays of text strings during BIOS activity

(75) Inventor: Brandon Burrell, Suwanee, GA (US)

Correspondence Address: MERCHANT & GOULD PC, P.O. BOX 2903, MINNEAPOLIS, MN, 55402-0903, US

(73) Assignee: American Megatrends, Inc.

(21) Appl. No.: 10/608,685

(22) Filed: Jun. 27, 2003

Related U.S. Application Data
(60) Provisional application No. 60/444,323, filed on Jan. 31, 2003.

(51) Int. Cl. G06T 11/00

(52) U.S. Cl. 345/467; 715/529

(57) ABSTRACT

Methods and computer systems render displays of text strings during bios activity by utilizing escape codes within the strings to signify that portions of the text strings are to be displayed in various formats. One escape code signifies one format, such as bold typeface while another escape code signifies another format, such as underlined. A display engine of the BIOS when generating the display of text strings encounters the escape codes, interprets them to determine the format for the subsequent text, and renders the display of the subsequent text in the corresponding format.

### RELATED APPLICATIONS

This application claims priority to U.S. Provisional Application No. 60/444,323 filed on Jan. 31, 2003 and entitled ESCAPE SEQUENCE CONTROL OF BIOS DISPLAY ATTRIBUTES, which is incorporated herein.

### TECHNICAL FIELD

The present invention relates to displays of text strings in a computer system. More particularly, the present invention relates to the displays of text strings in a computer system during BIOS activity with the portions of the text strings being displayed in various formats.

### BACKGROUND

A computer system utilizes a basic input/output system (“BIOS”) for various purposes. The BIOS is computer code stored on a ROM device of the computer system that is implemented by a processor of the computer when the computer boots up. The BIOS provides the interface between the software of the computer system, namely the operating system, to the hardware devices.

The BIOS performs activities during the boot up of the computer system including a power on self-test (“POST”) as well as a SETUP configuration tool. During POST, the BIOS confirms that core systems of the computer system are operational. At boot up, the user is given the option to enter the BIOS SETUP configuration mode where the user can manipulate various settings of the BIOS configured hardware, such as the input/output port settings and the system clock.

During such BIOS activities, the user is presented with text displayed on the screen. However, the text is a basic character set without any special formats and typefaces unless the BIOS code itself is written to display the text in a particular format. Even so, the display of text is very inflexible in that the BIOS code is not easily modified to change the particular format that may be used. Where the BIOS code is not written to provide any special display format, the textual display is very plain to the user. Furthermore, because the text is either basic or is displayed in a format fixed by the BIOS code, it is difficult to customize the emphasis of certain text that is particularly important and should not be overlooked by the user when viewing and interacting with the BIOS activity.

### SUMMARY

Embodiments of the present invention address these issues and others by providing text strings with embedded escape codes and providing BIOS code that interprets the embedded escape codes to determine the proper format to display the text string. When the BIOS code displays the text strings during BIOS activity, the BIOS code encounters the escape codes and interprets them to determine how to display the subsequent text. Accordingly, the escape codes of the text strings can be modified as desired, rather than the BIOS code itself, to alter the display of the text strings by the BIOS.

One embodiment is a method of providing a BIOS generated display of strings in a computer. The method involves providing a set of strings to be displayed by the BIOS. The method further involves providing a first escape code within a first string of the set, wherein the first escape code provides an indication of at least a portion of the first string that is to be displayed in a first format. When displaying the first string of the set, the first escape code is encountered and interpreted by a display engine of the BIOS to determine the first format and generate the display of the first string with the portion of the first string displayed in the first format.

Another embodiment is a method of providing a BIOS generated display of strings in a computer. The method involves providing a set of strings to be displayed by the BIOS during BIOS activity. A display of a first string is generated with a display engine of the BIOS, wherein at least a portion of the first string is displayed with a bold typeface.

Another embodiment is a method of providing a BIOS generated display of strings in a computer. The method involves providing a set of strings to be displayed by the BIOS during BIOS activity. A display of a first string is generated with a display engine of the BIOS, wherein at least a portion of the first string is displayed with an underlined typeface.

Another embodiment is a computer system for providing a BIOS generated display of strings in a computer. The computer system includes a display device, a processor, and a BIOS that stores a set of strings. A first escape code is provided within a first string of the set, wherein the first escape code provides an indication of at least a portion of the first string that is to be displayed in a first format by the BIOS when executed by the processor. The BIOS, when executed by the processor, encounters and interprets the first escape code to determine the first format and generates the display of the first string on the display device with the portion of the first string displayed in the first format.

### DESCRIPTION OF THE DRAWINGS

FIG. 1 is a diagram of a conventional computer system environment for embodiments of the present invention.

FIG. 2 is a diagram of illustrative BIOS display engine components of the computer system of FIG. 1 for implementing embodiments of the present invention.

FIG. 3 is an operational flow of BIOS code according to an illustrative embodiment of the present invention to display strings of text in various formats as dictated by escape codes embedded within the strings.

FIG. 4 is an operational flow of BIOS code according to an illustrative embodiment of the present invention to display at least a portion of a string of text with underlined characters.

FIG. 5 is an operational flow of BIOS code according to an illustrative embodiment of the present invention to display at least a portion of a string of text with boldface characters.

### DETAILED DESCRIPTION

Embodiments of the present invention provide a BIOS of a computer system that displays text strings in a format controlled by escape codes embedded within the text strings. When a text string is to be displayed in a certain format, the appropriate escape code is added to the text string. The BIOS code then recognizes the escape code and renders the display of the text with the appropriate format.

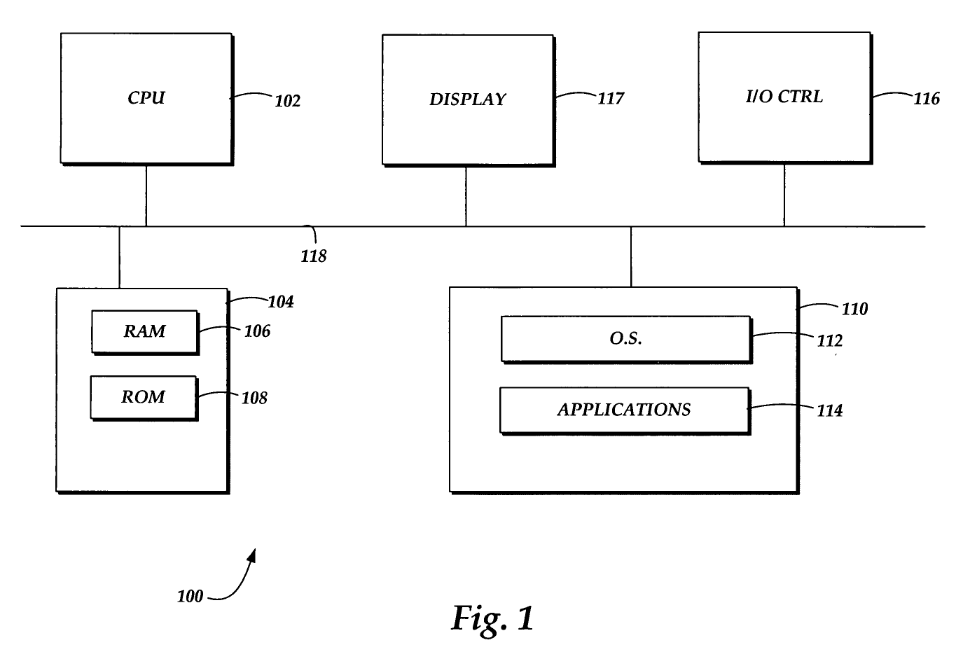

FIG. 1 shows a typical computer system 100 that provides an operational environment for embodiments of the present invention. The computer architecture shown in FIG. 1 illustrates a conventional personal computer, including a central processing unit 102 (“CPU”), a system memory 104, including a random access memory 106 (“RAM”) and a read-only memory (“ROM”) 108, and a system bus 118 that couples the memory to the CPU 102. A BIOS containing the basic routines that help to transfer information between elements within the computer, such as during startup including POST and SETUP, is stored in the ROM 108. The personal computer 100 further includes a mass storage device 110 for storing an operating system 112 and application programs 114. The mass storage device 110 is connected to the CPU 102 through a mass storage controller (not shown) connected to the bus 118. The personal computer 100 may also include an input/output controller 116 for receiving and processing input from a number of devices, including a keyboard or mouse (not shown). Similarly, a display controller 117 provides output to a display screen (not shown).

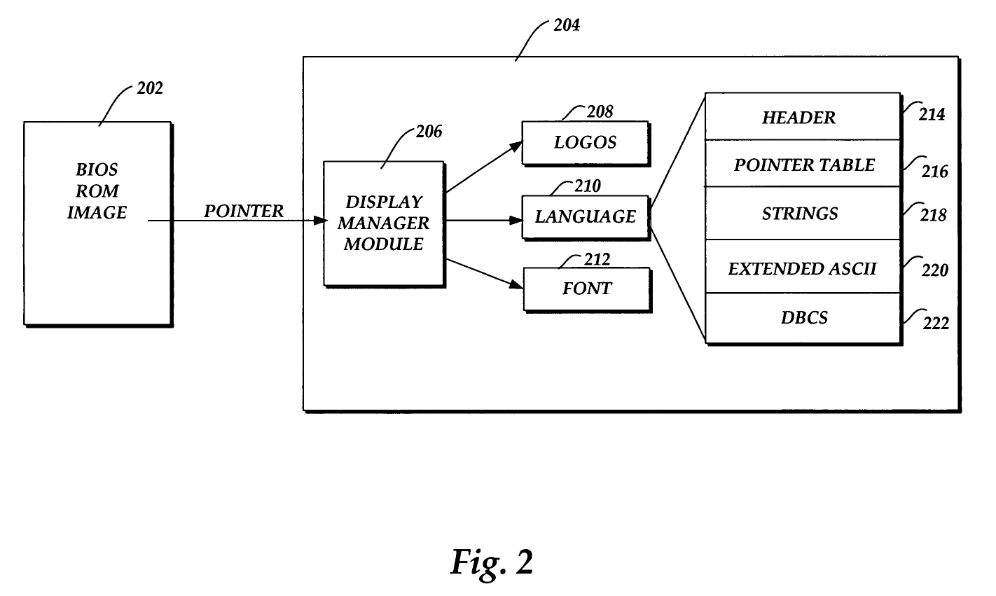

FIG. 2 shows an illustrative example of a display engine system 204 for a BIOS ROM image 202 stored in the ROM 108. The BIOS ROM image 202 contains the main BIOS code that performs the POST and SETUP functions of the BIOS. However, the main BIOS code may call upon various modules of the ROM image 202 when performing these functions. Specifically, during POST, the BIOS code searches the ROM image 202 for a compressed display engine module 206, expands it into RAM 106, and stores a pointer to it. The BIOS code then calls upon the display engine module 206 located at the stored pointer as necessary to render various displays during POST and SETUP.

The display engine system 204 of FIG. 2 is one example of a display engine of a BIOS ROM image 202. This display engine system 204 is discussed only for the purposes of illustration and is not intended to be limiting. It will be appreciated that various display engines capable of rendering displays of text in various formats based on embedded escape codes are also appropriate. While the display engine system 204 of FIG. 2 is discussed briefly herein, the details of this illustrative display engine system 204 can be found in U.S. patent application Ser. No. 09/686,402 and further in U.S. patent application Ser. No. 09/685,313, both of which are incorporated by reference herein.

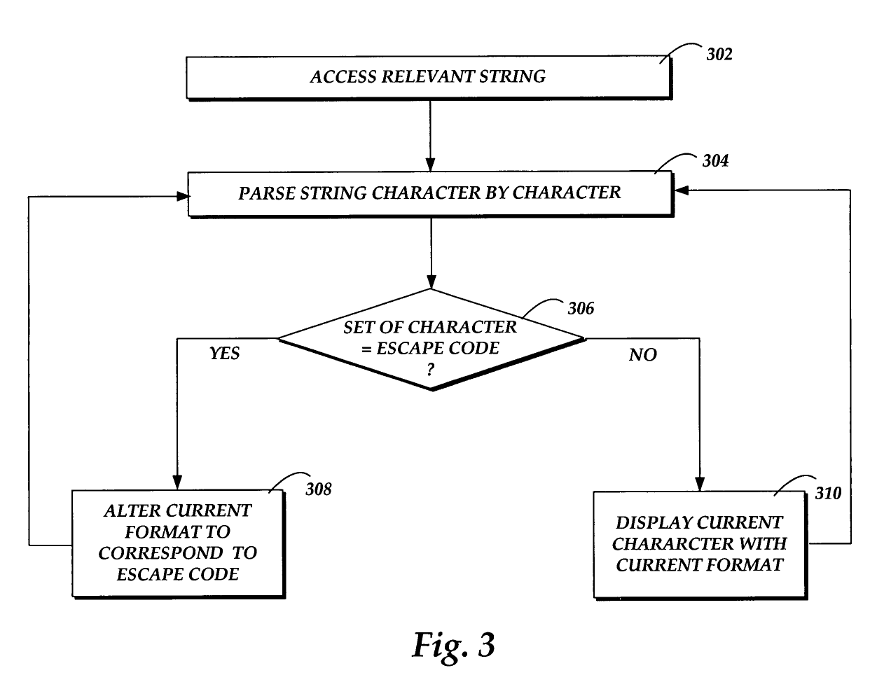

The display engine system 204 is a modular display engine that includes the display manager module 206 referenced above. The display manager module 206 includes logic to access sub-modules to render the display of graphics and/or text. According to an embodiment of the present invention, the display manager module 206 also incorporates logic to access strings of a language sub-module 210 where the strings may have embedded escape codes, and the logic recognizes the escape code and renders the display of the string accordingly. The logic for rendering the display in accordance with the escape code is discussed in more detail below with reference to FIG. 3.

The display manager module 206 may access several sub-modules. A logo sub-module 208 contains the data representative of logos to be displayed during POST or SETUP such as the logo of the manufacturer of the BIOS or the computer system. A language sub-module 210 contains the data representative of the text to be displayed during POST or SETUP such as the labels given to various entries in one page of the SETUP screen. A font sub-module 212 contains font information for rendering the text of the language module 210 in a desired font, such as default English text.

The details of the language sub-module 210 are also shown in FIG. 2. The language sub-module includes a header 214 identifying the language sub-module followed by a pointer table that contains pointers to the various sections of the sub-module. A first section of the language sub-module 210 is a strings section 218 that contains the strings to be displayed by the display manager module 206 during POST or SETUP. These strings include the characters to be displayed as well as any escape codes that have been embedded to control how the characters are rendered. For example, the escape codes may specify a background color, a foreground color, whether to underline, and whether to make bold. Examples of the text strings with embedded escape codes and the logic table for the escape codes are provided below and with reference to Table 1.

In addition to the strings section 218, the language sub-module may also contain an extended ASCII bitmaps section 220 which contains those ASCII characters that are not standard within a particular font as defined in the font sub-module 212 which contains the standard ASCII character set given by codepage 437. Additionally, the language sub-module 210 may contain a double byte character set (“DBCS”) section 222 which contains bitmap information for double byte characters such as those of languages with glyphs that will not fit within the single byte character space.

A set of illustrative logical operations performed by the display manager module 204 of the display engine embodiment of FIG. 2 is shown in FIG. 3. It will be appreciated that details of the logical flow may be altered for different display engines such that these logical operations are provided only for purposes of illustration and are not intended to be limiting.

The display manager module 206 receives a request from the main BIOS code during execution of POST or SETUP to display a string. The string may be identified by a token value provided from the main BIOS code to the display manager module 206. The display manager module 206 then accesses the relevant string at access operation 302 by searching within the string section 218 for the string associated with the token. Upon finding the string, the display manager module 206 begins parsing the string character by character at parse operation 304.

The string may or may not have embedded escape codes. The escape codes may be embedded by adding the characters of an escape code within the string where relevant prior to saving the string within the string section 218. Typically, strings may be saved in a central database location and are then accessed from the database and stored in the string section 218 during the build process for the BIOS. Thus, escape codes may be embedded within the strings stored in the central database so that the escape codes are transferred within the strings when saved to the string section 218.

The escape codes may be of various forms and the display manager module 204 may maintain a list of escape codes and their intended format for the characters of the string. Accordingly, the display manager module 204 parses through the strings at parse operation 304 character by character to determine if a set of the characters from the string form an escape code. Table 1 provides several examples of escape codes and their intended format as known by the display manager module 204.

TABLE 1

| Beginning Code | Cancel Code | Intended format Definition |
|---|---|---|
| $Aab | $AXX | Changes color where a is a |
| | | hexadecimal value for |
| | | background color and b is a |
| | | hexadecimal value for |
| | | foreground color. |
| $EUE | $EUX | Enable and Disable |
| | | underlining. |
| $EBE | $EBX | Enable and Disable |
| | | boldface. |

Thus, when a string contains $Aab, where a and b are hexadecimal values 0-F, then the display manager module 204 recognizes an escape code which indicates that subsequent text in this string should be display with a background color defined by a and a foreground (i.e., text) color defined by b. When the display manager module 204 encounters $AXX, which is the cancel code for color control, then the display manager module 204 recognizes that the color for the subsequent text should return to a default setting, such as the color originally given in the string display call. For example the color originally given in the string display call may define a black background and a white foreground.

The display manager module 206 detects whether an escape code has been encountered based on parsing through the characters of the string at query operation 306. Thus, if a set of characters of the string match one of the escape codes, either a beginning code or a cancel code, then operational flow transitions to format operation 308 where the display manager module 206 alters a current format for display of string characters to correspond to the escape code as dictated by the definition known for the escape code. Operational flow returns back to parse operation 304 to continue parsing the string to find another escape code and/or characters of the string that are to be displayed in the current format.

Where query operation 306 detects that a set of characters does not represent an escape code, then operational flow transitions to display operation 310. At display operation 310, the display manager module 204 generates a display of the current character, the first character of the set compared to the known escape codes, in the current format. Where no escape code has yet been provided for the current string, the current format is the default format, and the character is displayed in the format given during the initial string display call. However, where an escape code has already been encountered within the current string, the current format is the format defined by the escape code, and the character is displayed in that format. Operational flow then returns to parse operation 304 where the display manager module 206 parses the string for additional characters to display in the current format and/or for another escape code to alter the current format.

Examples of strings containing embedded escape codes and the resulting display are provided below.

### EXAMPLE 1

string: This is a multicolored $A04s$a0Ct$A0Er$A02i$A01n$A05g$AXX, and $EUEthis$EUX is $EUEunderlined!$EUX

resulting display: This is a multicolored string, and this is underlined! (Note that each letter of the word “string” is displayed in a different color while maintaining a consistent background.)

### EXAMPLE 2

string: $AE1Blue on yellow, $A4Eyellow on red, $AXXnow return to default.

resulting display: Blue on yellow, yellow on red, now return to default. (Note that “Blue on yellow,” is displayed with blue text on a yellow background, “yellow on red,” is displayed with yellow text on a red background, and “now return to default.” is displayed with the default text and background such as white and black, respectively.)

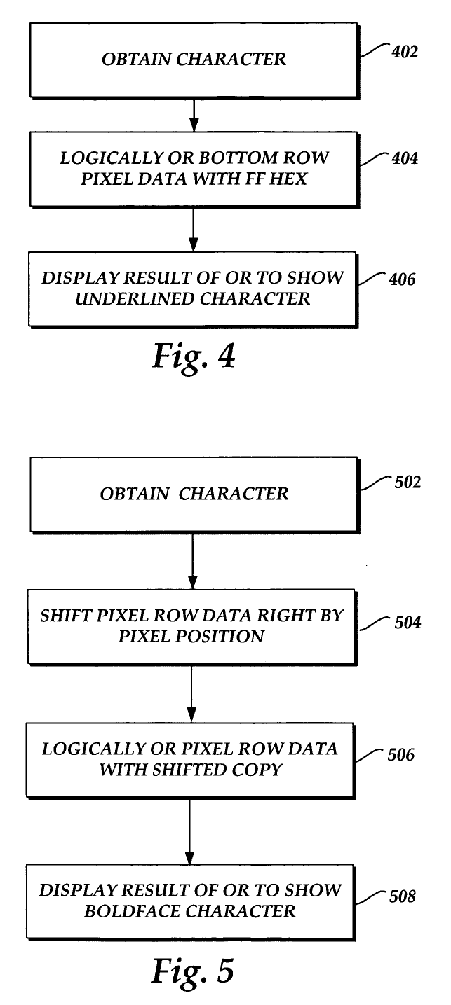

Text that is underlined or in boldface is not a standard text mode character. Accordingly, to provide underlining or boldface, the display manager module 206 executes in a graphics mode to draw the-characters rather than display characters of a standard text mode character font. FIG. 4 provides an illustrative set of logical operations for displaying underlined text when the BIOS renders displays in a graphics mode, such as during display screens of POST or SETUP. The display manager module 206 obtains a character as necessary for a string at character operation 402. The display manager 206 then performs a logical OR on the bottom row of the character data with hexadecimal value FF at OR operation 404. The display manager module 206 then displays the result which is the character with the bottom row of pixels of the character space activated as the underline at display operation 406.

FIG. 5 provides an illustrative set of logical operations for displaying boldface text when the BIOS renders displays in graphics mode. The display manager module 206 obtains a character as necessary for a string at character operation 402. As each row of the character is displayed, the display manager module 206 then shifts a copy of the row pixel information to the right by one pixel position at shift operation 504. The display manager module 206 then performs a logical OR on the character row data with its shifted copy at OR operation 506. The result is then displayed which results in the character having extra width that provides the boldface appearance at display operation 508.

Although the present invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method of providing a BIOS generated display of strings in a computer, comprising:
providing a set of strings to be displayed by the BIOS;
providing a first escape code within a first string of the set, wherein the first escape code provides an indication of at least a portion of the first string that is to be displayed in a first format;
when displaying the first string of the set, encountering and interpreting the first escape code by a display engine of the BIOS to determine the first format and generate the display of the first string with the portion of the first string displayed in the first format.

2. The method of claim 1, further comprising providing a cancel escape code within the first string and wherein the portion of the first string between the first escape code and the cancel escape code is displayed in the first format.

3. The method of claim 1, further comprising providing a second escape code within the first string of the set, wherein the second escape code provides an indication of at least a portion of the first string that is to be displayed in a second format, and wherein the portion of the first string between the first escape code and the second escape code is displayed in the first format and wherein the portion of the first string after the second escape code is displayed in the second format.

4. The method of claim 1, further comprising providing a third escape code within a second string of the set, wherein the third escape code provides an indication of at least a portion of the second string that is to be displayed in a third format.

5. The method of claim 1, wherein the first format is a bold typeface.

6. The method of claim 5, further comprising displaying the portion of the first string in the bold typeface by shifting a copy of each character pixel row data by one pixel position and performing a logical OR on each character row data with the shifted copy to control pixels that produce the display of each character of the portion.

7. The method of claim 1, wherein the first format is an underlined typeface, the method further comprising displaying the portion of the first string in the underlined typeface by controlling each bottom row pixel of each character of the portion.

8. The method of claim 1, wherein the first format is a first text color and a first background color.

9. A method of providing a BIOS generated display of strings in a computer, comprising:
providing a set of strings to be displayed by the BIOS during BIOS activity;
generating a display of a first string with a display engine of the BIOS, wherein at least a portion of the first string is displayed with a bold typeface.

10. The method of claim 9, further comprising providing a first escape code within the strings of the set, and wherein generating a display comprises encountering the first escape code to trigger the generation of the bold typeface.

11. The method of claim 9, wherein the bold typeface is generated by shifting a copy of each character row pixel data by one pixel position and performing a logical OR on each character row pixel data with the shifted copy to control pixels that produce the display of each character of the portion.

12. A method of providing a BIOS generated display of strings in a computer, comprising:
providing a set of strings to be displayed by the BIOS during BIOS activity;
generating a display of a first string with a display engine of the BIOS, wherein at least a portion of the first string is displayed with an underlined typeface.

13. The method of claim 12, further comprising providing a first escape code within the strings of the set, and wherein generating a display comprises encountering the first escape code to trigger the generation of the underlined typeface for the portion of the string following the escape code.

14. The method of claim 12, wherein the underlined typeface is generated by controlling each pixel of a low row of each character of the at least a portion of the first string.

15. A computer system for providing a BIOS generated display of strings in a computer, comprising:
a display device;
a processor; and
a BIOS that stores a set of strings, wherein a first escape code is provided within a first string of the set, wherein the first escape code provides an indication of at least a portion of the first string that is to be displayed in a first format by the BIOS when executed by the processor, and wherein the BIOS when executed by the processor encounters and interprets the first escape code to determine the first format and generates the display of the first string on the display device with the portion of the first string displayed in the first format.

16. The computer system of claim 15, further comprising providing a cancel escape code within the first string and wherein the portion of the first string between the first escape code and the cancel escape code is displayed in the first format.

17. The computer system of claim 15, wherein a second escape code is provided within the first string of the set, wherein the second escape code provides an indication of at least a portion of the first string that is to be displayed in a second format, and wherein the portion of the first string between the first escape code and the second escape code is displayed in the first format and the portion of the first string after the second escape code is displayed in the second format.

18. The computer system of claim 15, further comprising providing a third escape code within a second string of the set, wherein the third escape code provides an indication of at least a portion of the second string that is to be displayed in a third format.

19. The computer system of claim 15, wherein the first format is a bold typeface.

20. The computer system of claim 19, wherein the BIOS generates the display of the portion of the first string in the bold typeface by shifting a copy of each character pixel row data by one pixel position and performing a logical OR on each character pixel row data with the shifted copy to control pixels that produce the display of each character of the portion.

21. The computer system of claim 15, wherein the first format is an underlined typeface and wherein the BIOS generates the display of the portion of the first string in the underlined typeface by controlling each bottom row pixel of each character of the portion.

22. The computer system of claim 15, wherein the first format is a first text color and a first background color.
